(19) United States
(12) Patent Application Publication
(10) Pub. No.: US 2015/0101640 A1
(43) Pub. Date: Apr. 16, 2015

(54) DEVICE AND METHOD FOR DE-ICING RAILWAY TRUCKS AND ORE CONCENTRATE IN RAILWAY TRUCKS

(71) Applicant: EPN SOLUTIONS AB, Piteå (SE)

(72) Inventors: Staffan Granström, Pitea (SE); Owe Johansson, Lulea (SE)

(73) Assignee: EPN SOLUTIONS AB, Piteå (SE)

(21) Appl. No.: 14/391,602

(22) PCT Filed: Apr. 3, 2013
(86) PCT No.: PCT/SE2013/050365

§ 371 Date: Oct. 9, 2014

(30) Foreign Application Priority Data
Apr. 10, 2012 (SE) 1250356-1

(51) Int. Cl. B60S 3/04

(52) U.S. Cl. CPC B60S 3/04
USPC 134/19; 134/123

(57) ABSTRACT

The invention relates to an arrangement for de-icing railway trucks and ore concentrate in railway trucks. The arrangement comprises a tunnel (2) having a number of discharge openings (3) for heated air which is used for de-icing and at least one exhaust opening (4) for used air. An air heater (5) is in communication with the discharge openings (3) through a supply air duct (6). The arrangement further comprises a water supply device arranged to supply water to the air heater (5) and/or the supply air duct (6). The capacity of the air heater (5) is high enough to heat the air to a temperature sufficient for vaporizing at least a portion of the water. The invention also relates to a corresponding method for de-icing.

### FIELD OF THE INVENTION

The present invention relates, in a first aspect, to a device for de-icing railway trucks and/or dressed ore in railway trucks.

In a second aspect, the invention concerns a method for such de-icing.

### BACKGROUND OF THE INVENTION

De-icing of railway trucks and dressed ore in railway trucks is a process that is intricate, energy demanding and has environmental impact aspects. Examples of known processes for this are disclosed, for instance, in U.S. Pat. No. 2,449,932, U.S. Pat. No. 2,507,775, U.S. Pat. No. 4,683,870, DE 19828899, DE 19921083, DD 152113, and RU2025430. However, known plants can only to a limited extent meet the requirements of rational and energy-efficient de-icing.

### DESCRIPTION OF THE INVENTION

The object of the present invention is to overcome the problems associated with traditional methods for de-icing and provide an improved process for this type of de-icing.

According to the invention, from its first aspect, this object is attained by a device of the kind in question having the special features defined in the characterizing clause of claim 1.

From the second aspect of the invention, the object is achieved by a method of the kind in question comprising the special measures defined in the characterizing clause of claim 8.

Preferred embodiments of the invention are defined in the dependent claims. It should be appreciated that further preferred embodiments may consist of each possible combination of features in the dependent claims and each possible combination of these with features that will be clear from the subsequent description including description of examples.

With the concept of tunnel in the present application, reference is made to what is conventionally meant by a tunnel, i.e., a building construction that has side walls, ceiling, and bottom but that is open in each end portion. With railway truck, also locomotives are understood in this application.

### BRIEF DESCRIPTION OF THE FIGURES

FIG. 1 is a flow chart of de-icing of railway trucks and locomotives.

FIG. 2 shows a locomotive and the principle of the injection of hot air and evacuation of cold air.

FIG. 3 shows in a diagram the principle of control and monitoring.

FIG. 4 shows a cross section of a tunnel including an ore truck.

FIG. 5 shows IR tiles of ceramic material between slits for the exhaust of hot air at high speed against the outside of the ore truck.

### DESCRIPTION OF EMBODIMENT EXAMPLES

### De-icing of Locomotives and Railway Trucks

Brief Functional Description

De-icing of ore concentrate in ore trucks is principally different from thawing of ice on railway trucks.

In de-icing of frozen moisture of ore concentrate, the truck body has to be heated from the outside to thaw a frozen layer of some millimetres for the ore concentrate to release from the wall upon unloading of the ore

In de-icing of railway trucks, the snow and ice caught on the under side of the truck, i.e., bogies and truck chassis, have to be thawed using a hot media, either hot water, steam, or hot air.

### De-icing Using Hot Water

Thawing using hot water is from a heat-transfer point-of-view most efficient, since the heat transfer with water is higher than for, for instance, air. However, de-icing using water has many disadvantages, among others:
Hot water has to be sprayed by high pressure to reach as large ice-covered surfaces as possible, which gives problems of penetration moisture in truck body, electric and electronic equipment of bogies and truck chassis.
Too low water temperature <50° C. together with remains from knocked down animals has turned out to give rise to Legionella bacteria, which requires an expensive and advanced purification of water.
For a quick de-icing of a train set, an accumulator is required having the size of 1000 m³ or more, which takes time to heat up. To heat 1 m³ of water from 40 to 60° C. in 1 h, a power of approx. 23.2 kW is required. To heat 1000 m³ of water 20° C., an installed power of approx. 23 MW is required, which, however, is possible with access to district heating or with electric energy

### De-icing Using Hot Air

De-icing using hot air gives a lower heat-transfer coefficient than water, which has to be compensated by higher temperature and air speed (flow). However, the air temperature has to be limited so that ice-free surfaces do not become overheated during the period for the thawing of ice-covered surfaces.

By injection of water that is evaporated in hot air into steam, the condensation heat of the steam can be utilized to increase the thawing of ice-covered surfaces, since the temperature of ice-covered surfaces is 0° C. and lower than the dewpoint of hot air.

The air has the advantage over water that it can pass parts being non-accessible also to water and does not give problem of penetration of moisture into electric and electronic equipment of bogies and truck chassis.

Heating of the air can be effected either using liquefied petroleum gas, natural gas, biogas, or oil, which is combusted in a hot-air generator that the air passes through, electric energy or steam.
Heating using liquefied petroleum gas or natural gas in a hot-air generator gives a compact and low investment plant having a quick start up time, since the energy transfer to the air takes place at high temperature. Heating using liquefied petroleum gas or natural gas gives a large flexibility, since water can be injected into the hot-air current in a relatively easy way.
Heating using electric energy requires large heat-transferring surfaces between electrically heated elements and the air, since the temperature of the electric heat-transferring elements is limiting.
Heating of the air using steam gives, like injection of water into hot air, a possibility of utilizing the condensation energy of the steam in the air upon the thawing of ice. The production of steam can be carried out either using combustion of liquefied petroleum gas, natural gas, biogas, or electric energy, but requires however a complicated plant with requirements of water treatment and safety equipment.

### Principle Solution, Flow Chart

For de-icing locomotives and railway trucks, it is suggested, in the circumstances of the above described advantages and disadvantages of different energy models, the use of hot air heated using a combustible gas in a combustion chamber 5 with the possibility of injecting water and utilizing the condensation energy of the steam to decrease the time for de-icing railway trucks.

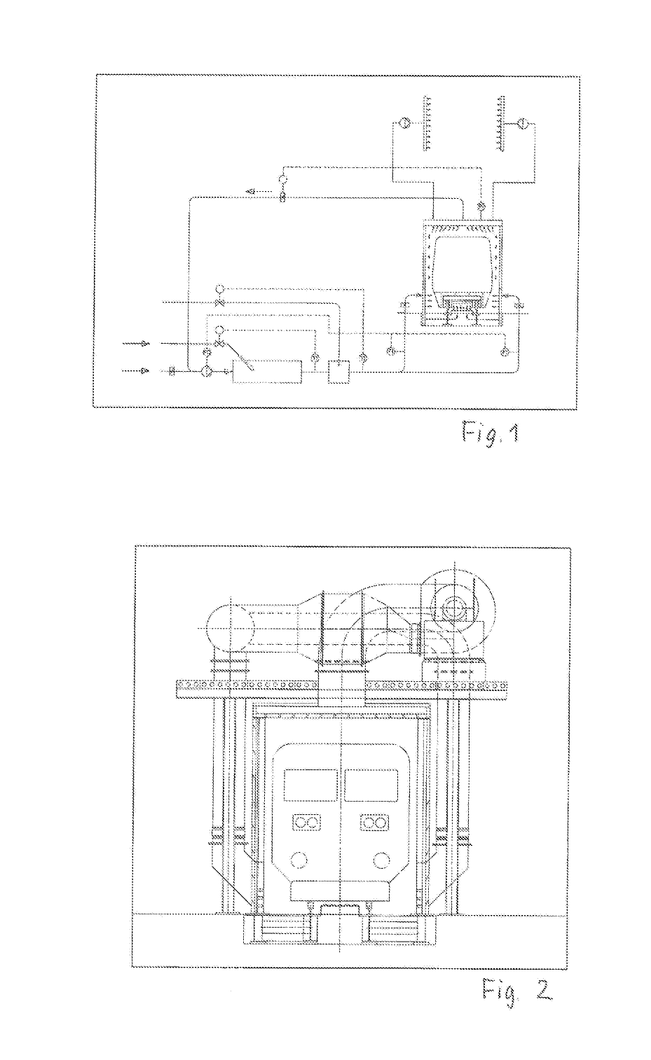

FIG. 1 shows in a flow chart the principle of the proposed plant for de-icing locomotives and railway trucks.

### Brief Description of Plant

According to experience from simulations and plant in operation, the air speed from incoming air should be in the order of 25-30 m/s to give a sufficiently high turbulence and a surface power in the order of 8 000-10 000 W/m². By condensation of injected water in the hot gas, the surface power can be doubled.

A train set 1 including locomotive and trucks passes through a tunnel 2 in which hot air is blown at high speed from longitudinal slits 3 in the lower parts of the tunnel walls and between the rail against the sides and bottom parts of chassis and bogies of locomotive and trucks to which snow and ice are frozen fast. When the air has passed the chassis and bogies, the air passes upward between tunnel walls and truck sides and is sucked through longitudinal slits 4 in the ceiling of the tunnel, after which the cooled air is recirculated through an insulated duct system 7 back to the hot-air generator 5 in order to be reheated. In-leaking ambient air in air curtains in the end portions of the tunnel is diverted from the main flow to air curtains in the in and out passages of the tunnel.

Parts of the duct network, hot-air fan, hot-air generator, etc., are placed in an apparatus room on a floor structure above the de-icing tunnel

In the hot-air generator 5, the air is heated by combustion of a combustible fuel, liquefied petroleum gas, natural gas, biogas, process gas, oil, or another combustible fuel.

The in and out passages in the tunnel end portions are provided with air curtains to decrease in-leakage of cold ambient air and out-leakage of hot air during de-icing and are provided with gates for saving heat energy and the possibility of preheating the tunnel to the desired temperature when the tunnel is not used for de-icing. The tunnel has a length that is adapted to give possibility to de-ice bogies, train sets with locomotive and trucks in the stated time. The length of the tunnel allows one or more trucks to be de-iced simultaneously, either by “moving de-icing” or “stationary de-icing” depending on how locomotive and trucks pass through the tunnel. The height of the tunnel is adapted to a suitable height with or without electric aerial line. The width of the tunnel is adapted to the width of the locomotive and trucks including sufficient safety distance to tunnel walls.

Above the de-icing tunnel on an upper storey, an apparatus room is located containing hot-air fan, hot-air generator, and externally heat-insulated air ducts for the distribution of hot air to and from the tunnel. In a surrounding building, a switch gear and operator room are installed in a container.

The tunnel is sectioned into modules, 5-6 m long, having controllable dampers for the possibility of controlling the air flow along locomotive and trucks so as to minimize temperature rise on ice-free surfaces during the course of de-icing.

Due to the requisite power and air flow for the de-icing and in order to decrease the size of gas ducts for supply and exhaust air, the plant has been divided into de-icing modules that can be installed in one or more consecutive modules to decrease the de-icing time.

The flow chart in FIG. 1 shows a de-icing module equal to the length of a bogie, truck, or several trucks installed one after the other.

At the in-passage and out-passage end of the plant, there are gates with air curtains to minimize in-leaking ambient air in the plant.

### Tunnel for the Injection of Hot Air and Evacuation of Return Air

FIG. 2 shows a tunnel with a locomotive and the principle of the injection of hot air and evacuation of cold return air.

### Duct System, Hot-Air Fan

The supply-air and exhaust-air ducts 3, 4 for the injection of hot air and evacuation of exhaust air are connected to a distribution duct for supply air and a distribution duct for exhaust air via each an externally insulated duct having adjustable damper for supply air and negative pressure and flexibles (compensators) for the compensation of length variations of the ducts.

The distribution duct for exhaust air 4 is connected to a hot-air fan 10 to maintain the air flow and pressure in the duct network. The number of revolutions of the hot-air fan is controlled by a frequency converter to maintain a desired flow of hot air to the tunnel. The air flow is measured by a flow sensor that regulates the rotational speed of booster fans.

### Hot-Air Generator

The hot-air generator 5 is installed after the hot-air fan. The hot-air generator 5 contains a number of liquefied petroleum gas-heated duct burners. The hot-air generator 5 is provided with its own control system and high-pressure fan for the combustion air. Fuel flow for the combustion air is controlled by a set value from the control system and temperature sensors in the supply-air flow.

### Gate Curtains

In each end of the de-icing plant, there is a so-called gate curtain having each an air curtain that blows air against the truck sides to prevent the ambient air from being sucked into the evacuation ducts. In the end of the gate curtains, there is a remote controlled hinged door, which normally is closed when de-icing is not carried out. Above the gates, there is installed a flexible wall of electrically insulating material for the passage of aerial line and collector shoe of locomotive and drive trucks. With the gates closed, heating and temperature retention can be effected at reduced flow and power.

### Environmental Aspects

Purification of “Bleed Off” Air

When return air and in-leaking ambient air are relatively free from dust, there is no need of purification of the air that has to be diverted from the gas duct network.

### Purification of Melt Water

Melt water and condensed steam from water injected into the supply-air ducts run down into the bottom of the rail bed and have to be discharged from the plant to a sewer system.

### Tunnel

Hot air is blown at high speed in longitudinal slits 3 in tunnel walls and bottom against chassis and bogies of locomotive and trucks and is sucked through the ceiling of the tunnel 1 back to hot-air generator 5 for reheating in a closed air duct network.

### Heating of Air

Heating of the air for de-icing is effected using combustion of a combustible fuel, liquefied petroleum gas, natural gas, biogas, process gas, oil, or the like in a duct burner of the duct network for the distribution of hot air to a tunnel for de-icing.

Injection of Water into Hot Air for Increasing De-icing Capacity
Water is injected by nozzles 11 after the duct burner to increase the moisture content of the hot air so as to then condense against cold surfaces with or without snow and ice with the purpose of increasing the de-icing capacity.

### De-icing of Dressed Ore Using Hot Air

Brief Functional Description

During the transportation from the loading terminal to the unloading terminal, the moist iron ore concentrate, the dressed ore, will freeze closest to the interior of the ore truck body into a shell the thickness of which varies along the contact surface of the truck body depending on transportation time, ore truck speed and temperature variations along the transport path. The objective of the de-icing of the ore is not to thaw all frozen dressed ore in the truck body but only a thin layer, 3-5 mm closest to the inside of the truck body by blowing hot air on the outside of the truck body.

Ore trucks having frozen dressed ore pass through a tunnel in which hot air is blown at high speed from longitudinal slits in the tunnel walls and between the rail against bottom, sides, and end portions of the bodies containing frozen ore concentrate. Parts of the tunnel walls are provided with refractory ceramic tiles 9 to boost the heat transfer from hot air by heat radiation. When the air has passed the trucks, it is sucked through longitudinal slits in the ceiling of the tunnel, after which the cooled air is recirculated through an insulated duct system back to the hot-air generator to be reheated. In-leaking ambient air in air curtains in the end portions of the tunnel is diverted from the main flow and is cooled by an intermixture of cold ambient air as well as in a heat exchanger by water. After the passage through the heat exchanger, the diverted air is led to a filter in the emptying hall for dust purification.

Parts of the duct network, hot-air fan, hot-air generator, etc., are placed in an apparatus room on a floor structure above the de-icing tunnel.

In the hot-air generator, the air is heated by combustion of liquefied petroleum gas from an LPG tank and an evaporator.

The in and out passages in the tunnel end portions are provided with air curtains to decrease in-leakage of cold ambient air and out-leakage of hot de-icing air during de-icing and are provided with gates for saving heat energy and possibility of preheating the tunnel to the desired temperature when the tunnel is not used for de-icing. The tunnel has a length that is adapted to give possibility of de-icing parts of half a line locomotive. The length of the tunnel allows one or more ore trucks to be de-iced simultaneously, either by “moving unloading” or “stop unloading” depending on how the ore trucks pass through the tunnel. The height of the tunnel is adapted to a suitable height with or without electric aerial line. The width of the tunnel is adapted to the width of the ore trucks including sufficient safety distance to tunnel walls upon possible asymmetric loading of iron concentrate and spring fracture in truck bogies.

Above the de-icing tunnel on an upper storey, an apparatus room is located containing hot-air fan, hot-air generator, and externally heat-insulated air ducts for the distribution of hot air to and from the tunnel. On the ground level inside the surrounding building, a switch gear and operator room are installed in a container.

In the same part of the building, there is a heat exchanger for cooling the diverted air installed with connecting ducts from the exhaust-air duct of the plant and to a filter for the purification of dust that is sucked from the trucks.

The plant is installed in a building.

The plant is controlled and monitored by a computer-based process control system.

After the truck emptying plant, there is a laser scanning system installed with the intention to scan the inside of the emptied trucks for checking that most of the iron concentrate has left the truck upon the emptying. If this has not been accomplished, a feedback is made to the process control system to change air temperature, air flow, and/or emptying speed.

### Safety

Since liquefied petroleum gas is a heavy gas and is used as fuel, gas leakage has to be indicated by liquefied petroleum gas leakage sensors placed in the vicinity of the LPG tank, evaporator and inside the apparatus room at the hot-air generator. When a liquefied petroleum gas leakage has been indicated, the gas supply is shut off from the LPG tank by a safety valve, after which an alarm signal for gas alarm begins and the plant is stopped. Before the plant can be started again, the gas leakage has to be located and taken care of.

To ensure that no person has passed into the tunnel in case no ore trucks are present in the tunnel and when the holding of the tunnel begins, a photo-electric trip device is activated, and after which the holding begins and the doors are opened.

### Environmental Aspects

Purification of Diverted Air from Dust

Since the ore and dust can be released from over the surface of the ore in the truck and from truck chassis and bogie during the de-icing, after cooling in the heat exchanger, the diverted air is sucked to the dust filter for the emptying hall of a duct system. To cool the diverted air to allowed temperature, a thermally operated damper for cooling the diverted air is installed before the heat exchanger.

Draining of Melt Water from Snow and Ice on Ore Trucks

Water from melted snow and ice on the ore trucks will drip to the bottom of the rail bed foundation and has to be drained to a sewer system.

### Process Control

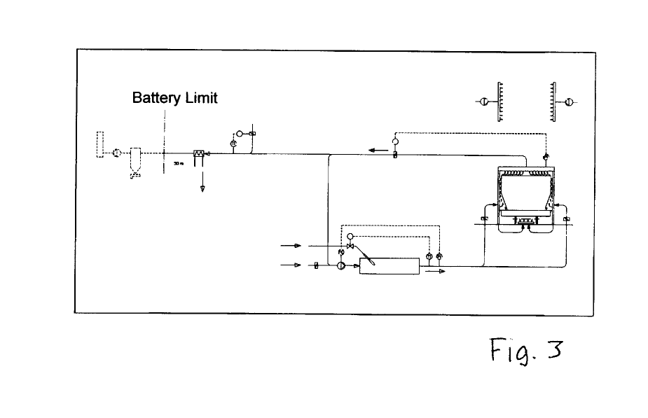

The plant is controlled and monitored by a process control system using measurements and indications of air flows, air temperatures, speed control of hot-air fan, regulation of fuel feed, combustion air and damper, monitoring, alarming, reporting, and communication with superior process control system. The plant can be controlled from a local control desk in the switch gear room as well as from a control desk in a superior process control system. The principle of control and monitoring is shown in FIG. 3

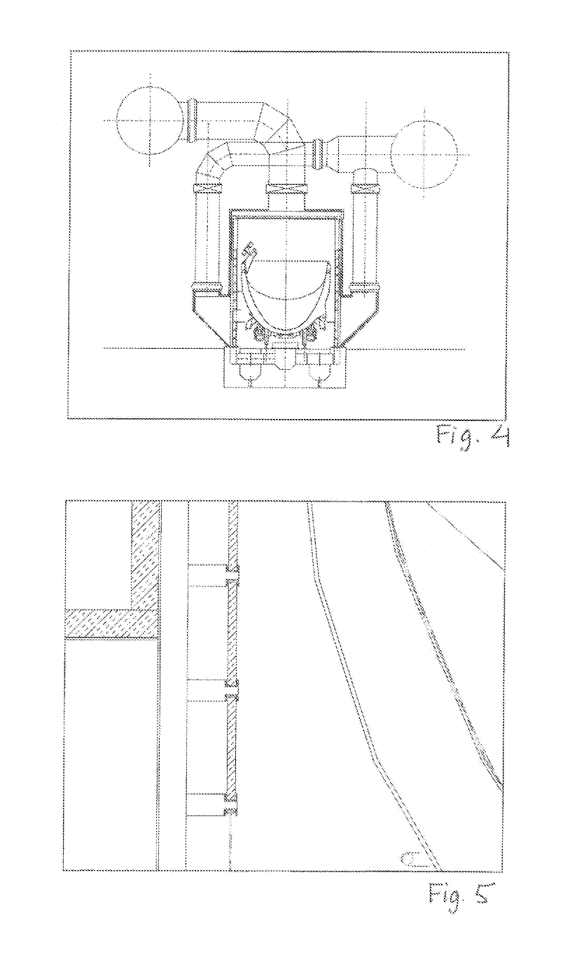

Cross section of a tunnel with ore truck is shown in FIG. 4.

FIG. 5 shows IR tiles 9 of ceramic material between slits for the exhaust of hot air at high speed against the outside of the ore truck. The IR tiles are heated by the hot air on the back side and front side and contribute to the heat transfer by heat radiation.

### Tunnel

1 Hot air is blown at high speed in longitudinal slits in tunnel walls and bottom against truck body containing iron concentrate, ore, or dressed ore and is sucked through the ceiling of the tunnel back to the hot-air generator for reheating in a closed air duct network.

2 Between the air gaps and the other surfaces, the tunnel walls are provided with IR tiles of ceramic material for boosting the heat transfer to the truck body of the ore truck.

### Heating of Air

Heating of the air for de-icing is effected using combustion of a combustible fuel, liquefied petroleum gas, natural gas, biogas, process gas, oil, or the like in a duct burner of the duct network for the distribution of hot air to tunnel for de-icing.

1. Device for de-icing railway trucks (1) and/or dressed ore in railway trucks, which device comprises a tunnel (2) provided with a plurality of injection openings (3) for heated air to be used for de-icing and at least one evacuation opening (4) for used air, which device furthermore comprises a hot-air generator (5) that, by supply-air duct means (6), communicates with the injection openings (4), characterized in that the device furthermore comprises a water supply device arranged for the supply of water to the hot-air generator and/or the supply-air duct means, and in that the hot-air generator (5) is arranged with a capacity to heat the air sufficiently much so that at least a part of the supplied water should be evaporated.

2. Device according to claim 1, characterized in that said at least one evacuation opening (4) through exhaust-air duct means (7) communicates with the hot-air generator (5) for reheating, and that a closed duct system connects said at least one evacuation opening (4), the hot-air generator (5), and the injection openings to each other.

3. Device according to claim 1 or 2, characterized in that the injection openings comprise elongate slits (3) that run in the longitudinal direction of the tunnel (2), wherein the longitudinal direction is defined as the direction from one tunnel opening to the other.

4. Device according to any one of claims 1-3, characterized in that the injection openings (4) are arranged in the side walls of the tunnel (2) and/or the bottom of the tunnel (2).

5. Device according to any one of claims 1-4, characterized in that the hot-air generator (5) comprises a combustion device arranged for the combustion of fossil fuel, preferably in the form of gas.

6. Device according to any one of claims 1-5, characterized in that at least one tunnel opening, preferably both tunnel openings, is provided with a gate curtain that comprises air injection means for forming an air curtain at the respective tunnel opening.

7. Device according to any one of claims 1-6, characterized in that it is arranged to impart the air a speed through the exhaust openings in the interval of 15-60 m/s, preferably in the interval of 25-30 m/s.

8. Device according to any one of claims 1-7, characterized in that it is dimensioned to impart the air a heating power per unit area in the interval of 4-25 kW/m² upon contact with the railway truck, preferably in the interval of 8-10 kW/m².

9. Device according to any one of claims 1-8, characterized in that said at least one evacuation opening comprises a plurality of longitudinal slits arranged in the ceiling of the tunnel.

10. Device according to any one of claims 1-9, characterized in that the side walls of the tunnel are at least partly lined with a ceramic material.

11. Device according to any one of claims 1-10, characterized in that at least some of the injection openings are provided with dampers for the control of the speed of the air and/or the direction of the air.

12. Device according to any one of claims 1-11, characterized in that the tunnel, in the longitudinal direction, is composed of a plurality of building modules, with each module having a length in the interval of 3-10 m, preferably in the interval of 5-6 m.

13. Method for de-icing railway trucks and/or dressed ore in railway trucks, wherein each railway truck is driven into a tunnel and air is heated by a hot-air generator and the heated air is blown through injection openings against the railway trucks, characterized in that water is supplied to the hot-air generator and/or a supply-air means in such a way that it at least partly is evaporated by the same and then goes along with the heated air.

14. Method according to claim 13, characterized in that the method is exercised by means of a device according to any one of claims 1-12.
